(19) United States
(12) Patent Application Publication
(10) Pub. No.: US 2008/0213587 A1
(43) Pub. Date: Sep. 4, 2008

(54) Functionality-Latent Polyolefin Article and Process for the Production Thereof and Process for the Production of Functionality-Developed Polyolefin Article

(75) Inventors: Atsushi Kajita, Fukushima (JP); Shigeo Kogure, Kanagawa (JP); Yaichi Kato, Fukushima (JP)

Correspondence Address: NIXON & VANDERHYE, PC, 901 NORTH GLEBE ROAD, 11TH FLOOR, ARLINGTON, VA, 22203, US

(73) Assignee: UBE NITTO KASEI CO., LTD, Tokyo (JP)

(21) Appl. No.: 11/665,347

(22) PCT Filed: Nov. 8, 2005
(86) PCT No.: PCT/JP05/20784

§ 371 Date: May 29, 2007

(30) Foreign Application Priority Data
Nov. 12, 2004 (JP) 2004-328542

(51) Int. Cl. B32B 27/32; B32B 37/00

(52) U.S. Cl. 428/365; 428/394; 156/60; 428/523

(57) ABSTRACT

A functionality-latent polyolefin fiber that is capable of effectively exhibiting a predetermined function such as water repellency by heat treatment and has an oil agent and a function-imparting agent adhering to the surface thereof and that is to be heat-treated whereby the adherence amount of said oil agent is substantially decreased by penetration of said oil agent into the article and the function of the above function-imparting agent is exhibited.

### TECHNICAL FIELD

The present invention relates to a functionality-latent polyolefin article and a process for the production thereof and a process for the production of a functionality-developed polyolefin article.

### TECHNICAL BACKGROUND

Generally, polyolefin articles such as a polyolefin fiber, fabric, film, sheet, etc., are easily electrostatically chargeable and hence have various problems caused by static electricity. For example, when it is attempted to obtain a polyolefin fiber in the form of a multifilament, it is required to inhibit the generation of static charge for preventing the destruction of a take-up form during its take-up. In the case of chopped strands or staple fibers, it is required to inhibit the generation of static charge during a carding step, for example, in the production of a non-woven fabric, so that fibers are surface-modified by causing an oil agent containing a hydrophilic surfactant or an antistatic agent to adhere to fiber surfaces.

However, it is difficult to have any other function exhibited by causing the above oil agent to adhere to fiber surfaces, and for such a purpose, it has been only possible to optimize the adherence ratio of the oil agent and a function-imparting agent.

For example, when a fiber is imparted with a function such as water repellency, it is known that a fiber such as polyolefin fiber is subjected to water-repellency treatment in which a surface modifier containing a water repellent is caused to adhere to the surface of the fiber (for example, see JP-A-7-216737). However, when a non-woven fabric is to be obtained by employing, as a raw material, a fiber having the above surface modifier adhering thereto, preparing a web by a carding step and heat-processing the web, it has not yet been ensured due to stabilization of a processing step that a fiber can be imparted with contradicting performances of the antistatic property of the fiber and water repellency as a function of a non-woven fabric to such an extent that these functions are satisfactory.

For the exhibition of the contradicting functions by mixing a water repellent aiming at imparting its function as described above with an antistatic agent, studies have been therefore made for optimizing a mixing ratio (for example, see JP-A-10-46470).

Besides these, further, a film, sheet and fabric also have problems such as a similar failure during their take-up and adherence of a soiling and foreign matter.

### DISCLOSURE OF THE INVENTION

Under the circumstances, it is an object of the present invention to provide a functionality-latent polyolefin article that exhibits the property of preventing the generation of static electricity as is required during the production and processing of the article and that can also effectively exhibit a predetermined function such as water repellency or the like by heat treatment, a process for the production thereof and a process for the production of a functionality-developed polyolefin article from this functionality-latent polyolefin fiber.

For achieving the above object, the present inventors have made diligent studies, and as a result, they have found that a polyolefin article to the surface of which an oil agent having the property of penetrating the polyolefin article by heating adheres together with a function-imparting agent is suited for the object as a functionality-latent polyolefin article and that the above functionality-latent polyolefin article can be efficiently obtained by a process comprising the step of bringing a mixture containing an oil agent and a function-imparting agent into contact with a polyolefin article to cause the above oil agent and function-imparting agent to adhere to the surface thereof.

Further, it has been found that a functionality-developed polyolefin article can be obtained by a process comprising the step of heat-treating a functionality-latent polyolefin article obtained by the above process.

The present invention has been completed on the basis of the above finding.

That is, the present invention includes the following (1) to (15).

(1) A functionality-latent polyolefin article that is a polyolefin article having an oil agent and a function-imparting agent adhering to the surface thereof and that is to be heat-treated whereby the adherence amount of said oil agent is substantially decreased by penetration of said oil agent into the article and the function of said function-imparting agent is exhibited.

(2) A functionality-latent polyolefin article as recited in the above (1), which is at least one member selected from a polyolefin fiber, a fabric, a film and a sheet.

(3) A functionality-latent polyolefin article as recited in the above (2), wherein the polyolefin article is a polyolefin fiber.

(4) A functionality-latent polyolefin article as recited in any one of the above (1) to (3), wherein the oil agent is an oil agent that substantially does not volatilize under heat at 140° C. and, when the oil agent alone is caused to adhere, the oil agent ensures that the adherence amount of the oil agent when it is 0.2 to 0.5 mass % before heat treatment decreases to 0.01 to 0.2 mass % by heat treatment at 140° C. for 5 seconds and that the oil agent has an oil agent decrease ratio, represented by the expression (I), of 60% or more,

Decrease ratio (%) of oil agent adherence amount=[(A/B)/A]×100 (I)

wherein A is an adherence amount (mass %) of the oil agent adhering to the article before the heat treatment and B is an adherence amount (mass %) of the oil agent adhering to the article after the heat treatment.

(5) A functionality-latent polyolefin article as recited in the above (4), wherein the adherence amount of the oil agent before the heat treatment is 0.2 to 0.5 mass

(6) A functionality-latent polyolefin article as recited in any one of the above (1) to (5), wherein the oil agent contains, as a main component, an ester from a polyethylene glycol having a molecular weight of 400 to 800 and a fatty acid having 10 to 20 carbon atoms.

(7) A functionality-latent polyolefin article as recited in any one of the above (2) to (6), wherein the polyolefin fiber is a sheath-core type composite fiber using a polyethylene as a sheath component and a polypropylene as a core component.

(8) A functionality-latent polyolefin article as recited in any one of the above (1) to (7), wherein the function-imparting agent is at least one member selected from a water repellent and an oil repellent.

(9) A functionality-latent polyolefin article as recited in any one of the above (1) to (8), wherein the ratio of adherence amount of the function-imparting agent to the adherence amount of the oil agent before the heat treatment is from 0.3 to 2.0.

(10) A process for the production of a functionality-latent polyolefin article recited in any one of the above (1) to (9), which comprises the step of bringing a mixture containing an oil agent and a function-imparting agent into contact with a polyolefin article to cause said oil agent and said function-imparting agent to adhere to the surface of said polyolefin article.

(11) A process for the production of a functionality-developed polyolefin article, which comprises the step of heat-treating a functionality-latent polyolefin article obtained by the process recited in the above (10).

(12) A process for the production of a functionality-developed polyolefin article as recited in the above (11), which comprises the step of providing a functionality-latent polyolefin fiber as a functionality-latent polyolefin article and processing the functionality-latent polyolefin fiber and wherein the functionality-latent polyolefin fiber is heat-treated during and/or after the processing to obtain a functionality-developed polyolefin fiber article.

(13) A process for the production of a functionality-developed polyolefin article as recited in the above (12), wherein the heat treatment is carried out at a temperature between a softening start temperature of the polyolefin fiber surface and a thermal decomposition temperature of the polyolefin fiber surface.

(14) A process for the production of a functional polyolefin article as recited in the above (13), wherein the heat treatment is carried out at a temperature of 100 to 150° C. for 1 to 10 seconds.

(15) A process for the production of a functionality-developed polyolefin article as recited in any one of the above (12) to (14), wherein the functionality-developed polyolefin article obtained is a water-repellent, oil-repellent or water-repellent oil-repellent non-woven fabric.

According to the present invention, there can be provided a functionality-latent polyolefin article that not only exhibits the necessary property of preventing static electricity during the production or processing of the article, or before or during the use of a processed article, but also can effectively exhibit a predetermined function such as water repellency by heat treatment, a process for efficiently producing the above polyolefin article and a process for the production of a functionality-developed polyolefin article such as a water-repellent non-woven fabric from the above functionality-latent polyolefin fiber.

### BRIEF DESCRIPTION OF DRAWINGS

FIG. 1 is a chart of one example showing the result of thermogravimetric analysis (TGA) of a monoester of a polyethylene glycol having a molecular weight of 600 and oleic acid.

### PREFERRED EMBODIMENT OF THE INVENTION

The functionality-latent polyolefin article of the present invention is a polyolefin article having an oil agent and a function-imparting agent adhering to the surface thereof and having the property that, when it is heat-treated, the adherence amount of said oil agent is substantially decreased by the penetration of the oil agent into the article and the function of said function-imparting agent is exhibited.

The above “penetration of the oil agent into the article” means that the oil agent moves into the article by swelling or infiltration to come into a state where the oil agent is not extracted by the solvent extraction that will be discussed later.

While the form of the above functionality-latent polyolefin article is not specially limited, examples thereof include a fiber, a fabric, a film, a sheet, a plate-shaped article, a rod-shaped article and other structure. Further, the above form also includes an assembled article having any one of these articles arranged as the surface thereof. Of these articles, the functionality-latent polyolefin article is preferably used as an article having a product form that requires taking-up such as a fiber, a fabric, a film or a sheet or as an article to be processed.

While the polyolefin resin for use in the above functionality-latent polyolefin article is not specially limited, examples thereof include polyethylene resins (high-density polyethylene, low-density polyethylene, linear low-density polyethylene, an ethylene-propylene random copolymer, an ethylene-vinyl acetate copolymer (EVA), etc.), a polypropylene resin, a polyoxymethylene resin, etc. Further, various known additives may be added as required.

The polyolefin fiber is preferably a polyolefin fiber having thermal adhesiveness from the viewpoint of an operation for processing it into a fiber processed article such as a non-woven fabric. In particular, the polyolefin fiber include, for example, a sheath-core type or side by side type composite fiber using, as a low melting point component, a high-density polyethylene, a low-density polyethylene, a linear low-density polyethylene, an ethylene-propylene random copolymer, an ethylene-vinyl acetate copolymer (EVA), a polypropylene or polyoxymethylene and, as a high melting point component, a polypropylene, a polyester (PET, PBT, PPT) or a polyamide (nylon 6, nylon 66). Further, a single-component fiber can be also used so long as it has thermal adhesiveness. Of these, a sheath-core type fiber that uses, as a low melting point component (sheath component), a polyethylene, in particular, a high-density polyethylene and that uses, as a high melting point component (core component), a polypropylene, is the most preferred.

The oil agent that is caused to adhere to the surface of the above polyolefin fiber may be any oil agent and is not specially limited so long as it has the property of preventing the occurrence of static electricity and has the property of penetrating a fiber by heat treatment. The oil agent preferably contains, as a main component, an ester from a polyethylene glycol having a molecular weight of 400 to 800 and a fatty acid having 10 to 20 carbon atoms. When the polyethylene glycol component of the above ester has a molecular weight of less than 400, the oil agent is not easily dissolved in water and may have a problem in use. When it has a molecular weight of over 800, undesirably, the oil agent has high insulation resistance and is liable to cause the problem of occurrence of static electricity, for example, in a carding step. The fatty acid component in the above ester is preferably a fatty acid having a total number of carbons in the range of 10 to 20 in view of the effect of the present invention, and this fatty acid may be saturated or unsaturated and may be linear or branched. Examples of the above fatty acid include decanoic acid, lauric acid, myristic acid, palmitic acid, stearic acid, isostearic acid and oleic acid. Further, the form of the ester may be any one of a diester and a monoester, while a monoester is preferred in view of the effect of the present invention.

In the present invention, an oil agent containing one of the above polyethylene glycol fatty acid esters may be used or an oil agent containing two or more of them may be used. Alternatively, the oil agent may contain other known oil agent in addition to the above polyethylene glycol fatty acid(s) so long as the effect of the present invention is not impaired.

The function-imparting agent that is caused to adhere to the above polyolefin fiber surface together with the above oil agent is not specially limited, and examples thereof include a water repellent, an oil-repellent, a deodorant, a flame retardant or a fine-particle-imparting agent.

The above water repellent is not specially limited and can be selected from conventionally known water repellents such as a fluorine-containing compound, a silicone compound and a hydrocarbon compound, while a fluorine-containing compound is particularly preferred in view of the effect thereof.

As the above fluorine-containing water repellent, there can be employed, for example, a perfluoroalkyl-containing compound. This compound refers to a copolymer from a perfluoroalkyl-containing ethylenically unsaturated monomer and an ethylenically unsaturated monomer and has the performance of high water repellency. Examples of the perfluoroalkyl-containing ethylenically unsaturated monomer include perfluoroalkyl acrylate and perfluoroalkyl methacrylate. Further, examples of the ethylenically unsaturated monomer include alkyl acrylate and alkyl methacrylate having a long-chain alkyl group each.

The above perfluoroalkyl-containing ethylenically unsaturated monomer and the above ethylenically unsaturated monomer are emulsified in water in a mass ratio of 70:30 to 30:70 in the presence of a surfactant and copolymerized in the presence of an organic peroxide or the like as a catalyst, whereby the intended copolymer can be relatively easily obtained.

Further, the fluorine-containing water repellent can be also selected, for example, from an N-(n-propyl)-N-(β(meth)acryloxyethyl)perfluorooctylic acid amide or a perfluoroalkyl-containing urethane oligomer.

Some water repellents have not only water repellency but also oil repellency, and examples thereof include a fluorine compound having a fluorine carbide chain.

Commercially available products of the water repellents that also have oil repellency in combination include products having trade names such as “Fluoro Surf” (supplied by Fluoro Technology Corporation), “ZIRCOSET” (supplied by Shichifuku Chemical Co., Ltd.), “Water Guard” (supplied by Two-M Chemical Co., Ltd.), “NK Guard NDK-7E” (supplied by NICCA CHEMICAL CO., LTD) and the like.

The oil repellent includes silicone-containing oil repellents such as “SANREPEL” (supplied by SANYO KAKO CO., LTD.).

The deodorant includes an iron compound, a silver compound, a copper compound, a plant extract containing a mixture of various polyphenols, a combination of such a plant extract with phenoloxidase, and the like. Specific examples thereof preferably include iron ion, iron (II) chelate, silver ion, copper phthalocyanine, iron phthalocyanine, and the like.

The flame retardant includes halogen-free flame retardants and bromine-containing compounds, and specifically includes an aromatic bromine compound, an alicyclic bromine compound, an aliphatic bromine compound and a chemical containing an inorganic metal hydroxide, an inorganic metal oxide, an inorganic metal carbonate, a boron-containing compound, a sulfur-containing compound, a phosphoric ester-containing compound, an ammonium polyphosphate-containing compound, an (iso)cyanuric acid derivative compound, a cyanamide compound, a urea compound or the like.

The fine-particle-imparting agent is intended for imparting functionality or imparting the fiber surface with microscopic valleys and hills, and the fine particles include antibacterial fine particles, photocatalytic fine particle, adsorptive porous fine particles, talc fine particles, silica fine particles and the like. As antibacterial fine particles, not only fine particles of a known antibacterial compound but also fine particles supporting a known antibacterial agent such as silver ion can be used. As photocatalytic fine particles, known titanium oxide can be used, and besides this, fine particles having a porous coating formed of an inert compound such as silica can be also preferably used.

In the present invention, these function-imparting agents may be used singly, or two or more of them may be used in combination. From the viewpoint of the tenor of the present invention, a function-imparting agent that causes its function to exhibit effectively with a decrease in the content of the co-present oil agent is preferred. As such a function-imparting agent, for example, a water repellent can be employed.

In the functionality-latent polyolefin article of the present invention, the oil agent adhering to a surface penetrates the article under heat treatment, whereby the adherence amount thereof substantially decreases and the function-imparting agent adhering together with the above oil agent effectively exhibits its function.

That the adherence amount of the oil agent substantially decreases as described above means that the decrease ratio of the oil agent, determined by the expression (I) to be described later, is 10% or more.

When the functionality-latent polyolefin article of the present invention is a polyolefin fiber, the oil agent that is caused to adhere to the polyolefin fiber surface is desirably the above-described oil agent containing, as a main component, an ester from a polyethylene glycol having a molecular weight of 400 to 800 and a fatty acid having 10 to 20 carbon atoms. The above oil agent may be used singly or two or more esters may be used in combination.

The oil agent is an oil agent that substantially does not volatilize under heat at 140° C. and, when the oil agent alone is caused to adhere, the oil agent ensures that the adherence amount of the oil agent when it is 0.2 to 0.5 mass % before heat treatment decreases to 0.01 to 0.2 mass % by heat treatment at 140° C. for 5 seconds and that the oil agent has an oil agent decrease ratio, represented by the expression (I), of preferably 60% or more, particularly preferably 80% or more,

Decrease ratio (%) of oil agent adherence amount=[(A/B)/A]×100 (I)

wherein A is an adherence amount (mass %) of the oil agent adhering to the article before the heat treatment and B is an adherence amount (mass %) of the oil agent adhering to the article after the heat treatment.

The adherence amount of the oil agent to the polyolefin fiber before the heat treatment is preferably 0.2 to 0.5 mass %. When the adherence amount of the above oil agent before the heat treatment is at least 0.2 mass %, there is caused almost no trouble by the occurrence of static electricity, for example, in a carding step. When it is 0.5 mass % or less, the adherence amount of the above oil agent can be decreased by the penetration of the oil agent into the article by the heat treatment so as to be in the predetermined range after the heat treatment. The adherence amount of the oil agent before the heat treatment is determined more preferably in the range of 0.25 to 0.35 mass %.

Further, when the adherence amount of the oil agent after the heat treatment is in the range of 0.01 to 0.2 mass %, the function of the co-present function-imparting agent can be effectively exhibited and the heat energy required for the penetration of the oil agent into the fiber can be small. In view of a balance between the effective exhibition of function of the function-imparting agent and the heat energy, the adherence amount of the oil agent after the heat treatment is preferably determined in the range of 0.02 to 0.1 mass %.

The oil agent adherence amount before the above heat treatment and the oil agent adherence amount after the heat treatment are values measured by the following method.

That is, with a rapid residual oil extraction apparatus (“R-II type” supplied by Tokai Keiki K.K.), 2 g of a sample is subjected to the extraction of an adhering oil agent with 10 ml of a solvent containing ethyl alcohol and methyl alcohol in their mass mixing ratio of 2:1 under conditions of room temperature and an about 15 minutes' period twice, and an extracted oil agent is measured for an amount. Then, an oil agent adherence amount is determined on the basis of the expression (II).

Oil agent adherence amount (mass %)=[Extracted oil agent amount (g)/sample mass (g)]×100 (II)

Further, a decrease ratio of the oil agent adherence amount is calculated from the thus-determined oil agent adherence amounts obtained before and after the heat treatment on the basis of the above expression (I).

The function-imparting agent adhering to the polyolefin fiber surface together with the above oil agent before and after the heat treatment is measured for amounts by subjecting a sample to the extraction of the function-imparting agent with a solvent separately from, or simultaneously with the extraction of the oil agent, in the same manner as in the measurement of the above oil agent adherence amount. In this case, the solvent and the condition differ depending upon the kind of the above function-imparting agent, and it is required to properly select a solvent that does not dissolve the fiber and that has high compatibility with the function-imparting agent. For example, for the water repellent, there can be used a mixed solvent having a benzene/methanol mass mixing ratio of 1:1.

When the oil agent and the function-imparting agent can be extracted separately, they are extracted separately and then their adherence amounts are determined on the basis of the above expression (II) (method A). When the oil agent and the function-imparting agent cannot be separately extracted since they are co-extracted, the calculation results of adherence amounts of the oil agent before and after the heat treatment, obtained when the oil agent alone is caused to adhere under the same conditions, are used, and the adherence amount of the function-imparting agent is calculated by supposing that the oil agent penetrates the fiber like a case where the function-imparting agent is absent (method B). In this case, preferably, it is preferred to make a comparison with a case of an oil agent that does not penetrate the fiber, in order to confirm an improvement in functionality after the heat treatment.

The adherence amount of the function-imparting agent cannot be uniformly determined since it differs depending upon the kind of the function-imparting agent and a required function degree. When the function-imparting agent is a water repellent, and when it is used for imparting general water repellency or water slipperiness, the adherence amount thereof based on the polyolefin fiber is preferably 0.1 to 0.5 mass %, more preferably 0.2 to 0.3 mass % in view of a balance between its effect and economic performance.

Further, the amount ratio of the water repellent to the amount of the oil agent before the heat treatment is preferably in the range of from 0.3 to 2.0.

The method for producing the functionality-latent polyolefin article of the present invention can be any method and is not specially limited so long as it can cause the oil agent and the function-imparting agent to adhere to the polyolefin fiber surface, and various methods can be employed, while the functionality-latent polyolefin fiber can be efficiently produced by the process of the present invention to be described below.

The process of the present invention comprises the step of bringing a mixture liquid (“to be sometimes referred to as “surface treating liquid” hereinafter) containing the oil agent and the function-imparting agent into contact with the polyolefin article to cause the above oil agent and function-imparting agent to adhere to the surface of the polyolefin article.

When the polyolefin article is a polyolefin fiber, generally, a method in which the surface treating liquid is applied to the polyolefin fiber is employed as a method of bringing the surface treating liquid into contact with the polyolefin fiber. This application can be carried out at any stage such as a spinning step or a drawing step. Further, the application method includes a dip coating method (immersion method) in which the polyolefin fiber is dipped in the surface treating liquid, a spray coating method in which the surface treating agent is sprayed to the polyolefin fiber, a method in which the surface treating agent is applied to the polyolefin fiber with a brush or a roll coater, a putty drying method, and the like. Of these, a dip coating method is preferred in view of workability.

The process for the production of a functionality-developed polyolefin article, provided by the present invention, comprises the step of heat-treating a functionality-latent polyolefin article obtained by the above process.

When a functionality-latent polyolefin fiber is used as the functionality-latent polyolefin article, the process for the production of a functionality-developed polyolefin article, provided by the present invention, comprises the step of processing the above polyolefin fiber, and the polyolefin fiber is heat-treated during and/or after the processing thereby to cause the oil agent adhering to the polyolefin fiber surface to penetrate the fiber and decrease the adherence amount of the oil agent on the fiber surface. The above heat treatment is preferably carried out at a temperature between a softening start temperature of the polyolefin fiber surface and a thermal decomposition temperature of the polyolefin fiber surface, more preferably at a temperature between 100° C. and 150° C. for 1 to 10 seconds.

The process for the production of a functionality-developed polyolefin article, provided by the present invention, is particularly preferred for producing a water-repellent, oil-repellent or water-repellent oil-repellent non-woven fabric.

The non-woven fabric is preferably formed by passing the above functionality-latent polyolefin fiber through a carding machine, then, causing the oil agent and the water repellent or oil repellent to adhere to the polyolefin fiber and then heat-treating the polyolefin fiber, for example, by the method of heat-fusing such as hot air fusing or hot roller fusing (including embossing roller fusing), since the adherence amount of the oil agent on the fiber can be decreased simultaneously with the fusing. Alternatively, in the formation of a non-woven fabric according to a non-heating method such as needle punching, the heat treatment is thereafter carried out, whereby the adherence amount of the oil agent on the fiber surface can be decreased like the heat-fusing.

While the fineness of the above polyolefin fiber that is used for the above formation of a non-woven fabric is not specially limited, the polyolefin fiber preferably has a fineness of approximately 1.0 to 20.0 dTex in view of use of a heat-fused non-woven fabric.

### EXAMPLES

The present invention will be explained further in detail with reference to Examples hereinafter, while the present invention shall not be limited by these Examples.

Various property values in Examples were determined according to the following methods.

(1) Adherence Amount of Oil Agent

Measured according to the method using the expression (II), described above in the present specification.

(2) Adherence Amount of Water Repellent

Measured according to the method B described above in the present specification. A solvent having a benzene/methyl alcohol mixing mass ratio of 1/1 was used as a solvent.

(3) Water Repellency

(a) Anti-Water Pressure

Measured according to 6.1 “Water resistance test (static pressure method) of JIS L 1092 “Water-proof test method of fiber articles”. Measurement results mean that the higher the anti-water pressure is, higher the water repellency is.

(b) Water Slipperiness

Under an atmosphere of 20° C. and 60% RH, 200 μL of water drops are allowed to stand on a hot air fused non-woven fabric having a basis weight of 30 g/m². The non-woven fabric is tilted at a rate of 18°/minute, and a tilt angle at a time when the water drops start to roll down is taken as a water slipping start angle. Measurement results mean that the smaller the angle is, the higher the water slipperiness is.

(4) Oil Repellency

A hot air fused non-woven fabric having a basis weight of 20 g/m² was measured according to the method of AATCC118-1992.

(5) Card Passing Property

A test raw fiber is passed through a sample roller card under an atmosphere of 20° C. and 70% RH, and a degree of occurrence of static electricity is visually observed when a web is discharged.

### Example 1

(1) Thermogravimetric Analysis of Polyethylene Glycol Oleic Monoester

A monoester of a polyethylene glycol having a molecular weight of 600 and oleic acid was subjected to thermogravimetric analysis as shown below.

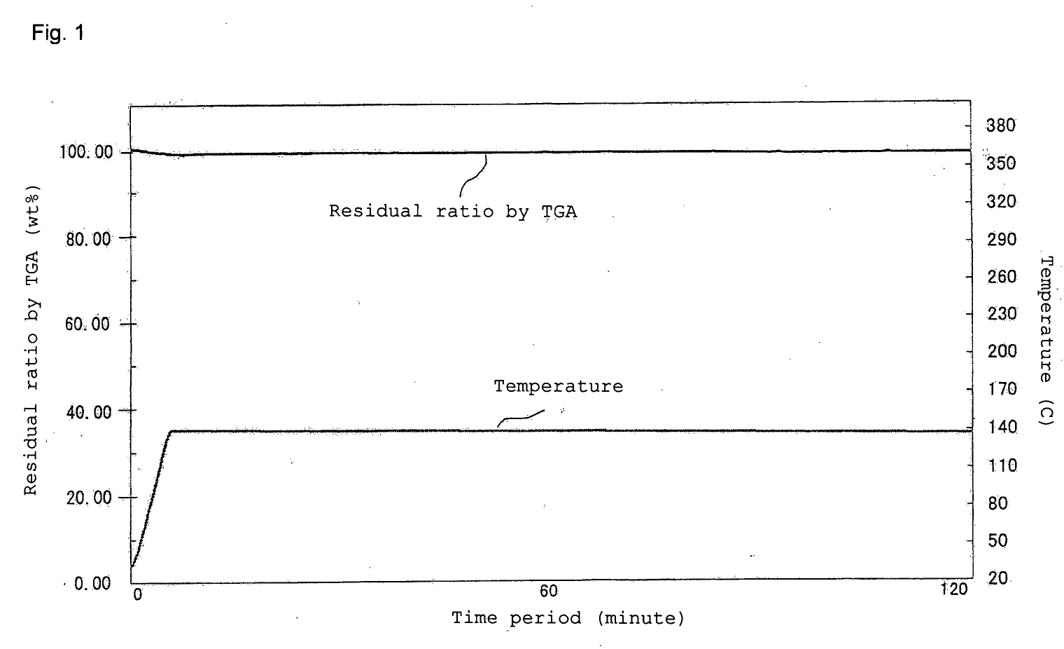

A sample was temperature-increased at a rate of 20° C./minute, maintained at 135° C. for 120 minutes and measured for a residual amount by TAG (thermogravimetric analysis). FIG. 1 shows the result.

As FIG. 1 clearly shows, it is seen that the above polyethylene glycol oleic monoester undergoes almost no volatilization or thermal decomposition at a temperature of 135° C.

(2) Preparation of Heat-Bonded Fiber

A sheath-core type composite fiber having a high density polyethylene (trade name: 120 YK, supplied by Idemitsu Kosan Co., Ltd.) as a sheath component and a polypropylene (trade name: Y2005GP, supplied by Idemitsu Kosan Co., Ltd.) as a core component was melt-spun according to a conventional method and then drawn. Then, the fiber was crimped with a stuffing box so as to have a crimp number of 6/cm and then an oil agent that was a monoester from a polyethylene glycol having a molecular weight of 600 and a oleic acid and a fluorine-resin-containing water repellent (trade name: NK GUARD NDN-7E, supplied by NIKKA CHEMICAL CO., LTD.) were caused to adhere to the fiber such that the adherence amount of the oil agent was 0.35 mass % and that the adherence amount of the water repellent was 0.30 mass %. The fiber was heat dried and cut to give a PE/PP heat-bonded fiber having a fineness of 2.2 dTex and a length of 51 mm.

Incidentally, the oil agent and the water repellent were caused to adhere to the fiber by employing a dipping method in which the fiber is dipped in a mixture thereof.

(3) Processing of Non-Woven Fabric

The thus-obtained short fiber was opened with a carding machine to form a web and then the web was passed through a hot air fusing machine at 140° C. for 5 minutes to give an air through non-woven fabric.

(4) Evaluation

Table 1 shows adherence amounts of the oil agent and the water repellent on the fiber surface before and after the heat treatment, static electricity in the carding, water repellency (anti-water pressure, water slipping start angle) and oil repellency.

The thus-obtained raw fiber was excellent in the property of passing through a carding machine and free from the occurrence of static electricity, and the web was excellent in texture. Further, it had an anti-water pressure of 59 mm and thus had sufficient water repellency, and it had a water slipping start angle of 9.9° and thus had excellent water slipperiness.

The obtained non-woven fabric was evaluated for oil repellency according to the method of AATCC118-1992 to show 7.5 (class) and it was confirmed that the non-woven fabric also had oil repellency together with water repellency.

### Examples 2 and 3

Example 1 was repeated except that the adherence amounts of the oil agent and the water repellent before the heat treatment were changed as shown in Table 1. Table 1 shows the results.

In Example 2, the thus-obtained fiber was excellent in the property of passing through a carding machine and free from the occurrence of static electricity. Further, a web had an anti-water pressure of 67 mm and thus had a sufficient function as a water-repellent non-woven fabric. It had a water slipping start angle of 8.5° and thus had excellent water slipperiness.

In Example 3, the thus-obtained fiber was excellent in the property of passing through a carding machine and free from the occurrence of static electricity. Further, a web had an anti-water pressure of 52 mm and thus had sufficient water repellency. It had a water slipping start angle of 10.5° and thus had excellent water slipperiness.

### Example 4

Example 1 was repeated except that a monoester from a polyethylene glycol having a molecular weight of 400 and lauric acid was used as an oil agent and that the adherence amounts of the oil agent and the water repellent on the fiber surface before the heat treatment were changed as shown in Table 1. Table 1 shows the results.

The thus-obtained fiber was excellent in the property of passing through a carding machine and free from the occurrence of static electricity. Further, a web had an anti-water pressure of 60 mm and thus had a sufficient function as a water-repellent non-woven fabric. It had a water slipping start angle of 9.8° and thus had excellent water slipperiness.

### Comparative Examples 1-3

Example 1 was repeated except that the oil agent was changed to an alkyl phosphate potassium salt (hydrophilic oil agent) whose alkyl chain had 8 carbon atoms and that the amounts of the oil agent and the water repellent on the fiber surface before the heat treatment were changed as shown in Table 1. Table 1 shows the results.

In all of Comparative Examples 1 to 3, webs had low anti-water pressures and were not sufficient as a water-repellent non-woven fabric. Further, they had large slipping start angles and were poor in water slipperiness.

### Comparative Examples 4-6

Example 1 was repeated except that the oil agent was changed to an alkyl phosphate potassium salt (water-repellent oil agent) whose alkyl chain had 16 carbon atoms and that the amounts of the oil agent and the water repellent on the fiber surface before the heat treatment were changed as shown in Table 1. Table 1 shows the results.

In Comparative Example 4, a web had an anti-water pressure of 61 mm and was sufficient as a water-repellent non-woven fabric. However, it had a water slipping start angle of 11°, which was large as compared with those in Examples 1 to 4.

In Comparative Example 5, no non-woven fabric could be produced due to the occurrence of static electricity.

In Comparative Example 6, a web had an anti-water pressure of as high as 67 mm, but it had a water slipping start angle of 14.6° and hence was poor in water slipperiness.

### Comparative Example 7

An attempt was made to repeat Example 1 except that 0.3 mass % of the water repellent alone was caused to adhere the fiber surface without using the oil agent. In a carding step, however, no non-woven fabric could be produced due to the occurrence of intense static electricity on the fiber. Table 1 shows the results.

### Table 1

TABLE 1

| | | | Surface | | | | | | | |
|---|---|---|---|---|---|---|---|---|---|---|
| | | | adherence | | Surface adherence | | Oil | | | |
| | | | amount | | amount after | | agent | Static | Anti- | Water |
| | | Property | (mass %) | | heating (mass %) | | decrease | electricity | water | slipping |
| | | of | Oil | Water | Oil | Water | ratio | in | pressure | start |
| | Oil agent | lubricant | agent | repellent | agent | repellent | (%) | carding | (mm) | angle (°) |
| Ex. 1 | Monoester from | Hydrophilic | 0.35 | 0.30 | 0.05 | 0.30 | 86 | ∘ | 59 | 9.9 |
| Ex. 2 | polyethylene having | | 0.20 | 0.30 | 0.03 | 0.30 | 85 | ∘ | 67 | 8.5 |
| Ex. 3 | molecular weight of | | 0.35 | 0.15 | 0.05 | 0.15 | 86 | ∘ | 52 | 10.5 |
| | 600 and oleic acid | | | | | | | | | |
| Ex. 4 | Monoester from | Hydrophilic | 0.35 | 0.30 | 0.05 | 0.30 | 86 | ∘ | 60 | 9.8 |
| | polyethylene having | | | | | | | | | |
| | molecular weight of | | | | | | | | | |
| | 400 and lauric acid | | | | | | | | | |
| CEx. 1 | Alkyl phosphate | Hydrophilic | 0.35 | 0.30 | 0.33 | 0.30 | 5.7 | ∘ | 27 | 15.2 |
| CEx. 2 | potassium salt whose | | 0.20 | 0.30 | 0.19 | 0.30 | 5.0 | ∘ | 29 | 16.5 |
| CEx. 3 | alkyl chain had 8 | | 0.35 | 0.15 | 0.33 | 0.15 | 5.7 | ∘ | 18 | 18.0 |
| | carbon atoms | | | | | | | | | |
| CEx. 4 | Alkyl phosphate | Water- | 0.35 | 0.30 | 0.33 | 0.30 | 5.7 | ∘ | 61 | 11.4 |
| CEx. 5 | potassium salt whose | repellent | 0.20 | 0.30 | 0.19 | 0.30 | 5.0 | x | — | — |
| CEx. 6 | alkyl chain had 16 | | 0.35 | 0.15 | 0.33 | 0.15 | 5.7 | ∘ | 67 | 14.6 |
| | carbon atoms | | | | | | | | | |
| CEx. 7 | Nil | — | — | 0.30 | — | 0.30 | — | x | — | — |

Ex. = Example,
CEx. = Comparative Example
(Static electricity in carding: ∘: occurrence of no static electricity and excellence in the property of passing through a carding machine, x: no non-woven fabric producible due to the occurrence of static electricity)

### Example 5

Polyethylene pellets (HI-ZEX, supplied by Prime Polymer Co., Ltd.) was extruded by a T-die melt extrusion method according to a conventional method, to obtain a film having a thickness of 0.05 mm, and before a take-up step, an oil agent from a polyethylene glycol having a molecular weight of 600 and oleic acid and a fluorine-resin-containing water repellent (trade name: NK GUARD NDN-7E, supplied by NIKKA CEHIMICAL CO., LTD.) were caused to adhere such that the adherence amounts thereof were 0.1 mass % and 0.1 mass %, respectively. The film was dried and then taken up. The thus-obtained polyethylene film could be easily taken up.

Further, the film obtained was visually observed for an adhering state of dust, and as a result, almost no dust was adhering. The film was heat-treated at 140° C. for 5 seconds and then measured for a water slipping start angle to show 9.20.

### INDUSTRIAL UTILITY

According to the present invention, there can be provided a functionality-latent polyolefin article that exhibits the property of preventing the generation of static electricity as is required during the production and processing of the article or before and during the use of a processed article and that can also effectively exhibit a predetermined function such as water repellency or the like by heat treatment, a process for the production of the above polyolefin article and a process for the production of a functionality-developed polyolefin article such as a water-repellent non-woven fabric from this functionality-latent polyolefin fiber.

1. A functionality-latent polyolefin article that is a polyolefin article having an oil agent and a function-imparting agent adhering to the surface thereof and that is to be heat-treated whereby the adherence amount of said oil agent is substantially decreased by penetration of said oil agent into the article and the function of said function-imparting agent is exhibited.

2. The functionality-latent polyolefin article of claim 1, which is at least one member selected from a polyolefin fiber, a fabric, a film and a sheet.

3. The functionality-latent polyolefin article of claim 2, wherein the polyolefin article is a polyolefin fiber.

4. The functionality-latent polyolefin article of claim 1, wherein the oil agent is an oil agent that substantially does not volatilize under heat at 140° C. and, when the oil agent alone is caused to adhere, the oil agent ensures that the adherence amount of the oil agent when it is 0.2 to 0.5 mass % before heat treatment decreases to 0.01 to 0.2 mass % by heat treatment at 140° C. for 5 seconds and that the oil agent has an oil agent decrease ratio, represented by the expression (I), of 60% or more,
Decrease ratio (%) of oil agent adherence amount=[(A−B)/A]×100 (I)
wherein A is an adherence amount (mass %) of the oil agent adhering to the article before the heat treatment and B is an adherence amount (mass %) of the oil agent adhering to the article after the heat treatment.

5. The functionality-latent polyolefin article of claim 4, wherein the adherence amount of the oil agent before the heat treatment is 0.2 to 0.5 mass %.

6. The functionality-latent polyolefin article of claim 1, wherein the oil agent contains, as a main component, an ester from a polyethylene glycol having a molecular weight of 400 to 800 and a fatty acid having 10 to 20 carbon atoms.

7. The functionality-latent polyolefin article of claim 2, wherein the polyolefin fiber is a sheath-core type composite fiber using a polyethylene as a sheath component and a polypropylene as a core component.

8. The functionality-latent polyolefin article of claim 1, wherein the function-imparting agent is at least one member selected from a water repellent and an oil repellent.

9. The functionality-latent polyolefin article of claim 1, wherein the ratio of adherence amount of the function-imparting agent to the adherence amount of the oil agent before the heat treatment is from 0.3 to 2.0.

10. A process for the production of a functionality-latent polyolefin article recited in claim 1, which comprises the step of bringing a mixture containing a oil agent and a function-imparting agent into contact with a polyolefin article to cause said oil agent and said function-imparting agent to adhere to the surface of said polyolefin article.

11. A process for the production of a functionality-developed polyolefin article, which comprises the step of heat-treating a functionality-latent polyolefin article obtained by the process recited in claim 10.

12. The process for the production of a functionality-developed polyolefin article as recited in claim 11, which comprises the step of providing a functionality-latent polyolefin fiber as a functionality-latent polyolefin article and processing the functionality-latent polyolefin fiber and wherein the functionality-latent polyolefin fiber is heat-treated during and/or after the processing to obtain a functionality-developed polyolefin fiber article.

13. The process for the production of a functionality-developed polyolefin article as recited in claim 12, wherein the heat treatment is carried out at a temperature between a softening start temperature of the polyolefin fiber surface and a thermal decomposition temperature of the polyolefin fiber surface.

14. The process for the production of functionality-developed polyolefin article as recited in claim 13, wherein the heat treatment is carried out at a temperature of 100 to 150° C. for 1 to 10 seconds.

15. The process for the production of a functionality-developed polyolefin article as recited in claim 12, wherein the functionality-developed polyolefin article obtained is a water-repellent, oil-repellent or water-repellent oil-repellent non-woven fabric.
